(19) United States
(12) Patent Application Publication
(10) Pub. No.: US 2001/0023618 A1
(43) Pub. Date: Sep. 27, 2001

(54) Rolling-body screw drive and method of assembling the same

(75) Inventor: Erich Huppmann, Sommersdorf (DE)

Correspondence Address: Baker Botts L.L.P., 30 Rockefeller Plaza, New York, NY, 10112-4498, US

(73) Assignee: Rexroth Star GmbH, Schweinfurt (DE)

(21) Appl. No.: 09/783,468

(22) Filed: Feb. 14, 2001

(30) Foreign Application Priority Data
Feb. 15, 2000 (DE) 100 06 536.8

(51) Int. Cl. F16H 3/06; F16H 27/02; F16H 29/02; F16H 29/20

(52) U.S. Cl. 74/89.42

(57) ABSTRACT

A rolling-body screw drive (10a) comprises a threaded spindle (12a) with a spindle axis (S), and a double nut (14a) which runs on the threaded spindle (12a) and has two separately formed individual nuts (16a, 18a) which are connected essentially rigidly to one another in the direction of the spindle axis (S). In this case, for setting a desired level of play or a desired prestressing in relation to the threaded spindle (12a), the two individual nuts (16a, 18a) can be rotated continuously relative to one another about the spindle axis (S) and can be secured in any desired rotary position relative to one another corresponding to the desired level of play or the desired prestressing. Furthermore, an annular disk (28a), which is connected to a first (16a) of the two individual nuts, is arranged between the two individual nuts and has its disk plane running essentially orthogonally to the spindle axis (S), is pressed, by way of at least one circumferential section (64a), into an associated recess (66a) of the second individual nut (18a).

The invention relates to a rolling-body screw drive, in particular a ball screw drive, comprising a threaded spindle with a spindle axis, and a double nut which runs on the threaded spindle and has two separately formed individual nuts which are connected essentially rigidly to one another in the direction of the spindle axis, it being the case that, for setting a desired level of play or desired prestressing in relation to the threaded spindle, the two individual nuts can be rotated continuously relative to one another about the spindle axis and can be secured in any desired rotary position relative to one another corresponding to the desired level of play or the desired prestressing.

Such rolling-body screw drives are used, for example, for the rapid and precise positioning of tool and workpiece carriers and for the displacement of the same at defined speeds. In this case, a rotary movement of the threaded spindle is converted into a linear movement of the guided double nut. In order for it to be possible to meet the highest possible accuracy-related requirements upon reversal of the movement direction of the double nut, it is necessary for the double nut to be arranged as far as possible in a play-free manner on the spindle. For this purpose, during assembly, the two nuts are rotated toward one another on the spindle until they are supported on one another by way of their mutually facing end surfaces. Further rotation of the nuts results in the rolling bodies butting against opposite flank surfaces of the running paths of the nuts, which ultimately results in the desired prestressing of the two nuts relative to the threaded spindle and the essentially play-free guidance of the double nuts on the threaded spindle.

A rolling-body screw drive of the generic type, i.e. a rolling-body screw drive in which the level of play or the prestressing of the two individual nuts in relation to the threaded spindle can be set in a stepless manner, as with the rolling-body screw drive according to the invention, is known, for example, from DE-A 21 35 812. Accommodated in an intermediate element, connected to one of the individual nuts in a rotationally fixed manner, of the known rolling-body screw drive is a screw-bolt which is in screw engagement with a part provided on the other individual nut in a rotationally fixed manner. The resulting worm drive allows stepless rotation of the two individual nuts relative to one another about the spindle axis. The disadvantage with this design is, firstly, that a relatively large amount of space has to be provided for the worm drive, in particular in the radial direction. However, it is also disadvantageous that, despite the self-locking inherent in worm drives, the desired prestressing set can be automatically adjusted again in an undesirable Manner, for example as a result of vibrations which result in a rotation of the screw-bolt of the worm drive.

A rolling-body screw drive of similar construction is also known from DE-A 23 49 958.

Furthermore, DE-A 23 49 958 and DE 30 38 774 C2, and the corresponding EP 0 049 903 B1, disclose rolling-body screw drives of the generic type in which, in order to prevent rotation of the two nuts relative to one another, an intermediate element is in frictional engagement both with the one individual nut and with the other individual nut. The frictional forces are thus overcome even at the assembly stage, i.e. during rotation of the two individual nuts relative to one another in order to set the desired prestressing or the desired level of play. This makes it considerably more difficult to set the level of play or the prestressing precisely to the desired value.

Furthermore, DE 24 53 635 C3, DE-A 25 33 996 and DE 29 40 762 C2 disclose rolling-body screw drives in which the two individual nuts can only be rotated relative to one another, and fixed, in predetermined angle steps rather than in a stepless manner.

In the case of the rolling-body screw drive known from German Utility Model 77 08 184, stepless rotation of the two individual nuts is possible only in a very narrow angle range. For setting a desired prestressing or desired level of play in relation to the threaded spindle, it is thus additionally necessary to provide, between the two individual nuts, spacer elements of which the thickness has to be coordinated with the desired prestressing or the desired level of play. During assembly, it is thus usually necessary, even for experienced personnel, to exchange the spacer elements a number of times until the spacer element which is of the correct thickness for the desired prestressing or the desired level of play has been found. The assembly of the rolling-body screw drive known from German Utility Model 77 08 184 is thus laborious and time-consuming.

According to DE 37 00 693 C2, a cavity which is formed by annular grooves and indents between the two individual nut end surfaces butting against one another is filled with sealing compound in order to form the intermediate element. The rotary position of the two individual nuts relative to one another corresponding to the desired prestressing or the desired level of play thus has to be maintained until the sealing compound has set completely. DE 42 08 126 A1 discloses a rolling-body screw drive in which the two individual nuts are connected to one another via an intermediate element which is resiliently compliant in the direction of the spindle axis. Such an axially resilient arrangement has the disadvantage that, when one of the individual nuts is subjected to a force exceeding the resilient force, the two individual nuts can be moved toward one another, as a result of which the desired prestressing is lost.

Furthermore, you are also referred to DE 32 07 566 A1, in which, once the desired prestressing of the two individual nuts has been set, an accommodating bore for a radial blocking bolt is made in the mutual contact region of the two individual nuts, said bolt ensuring that the prestressing achieved is maintained.

The object of the invention is thus to specify a rolling-body screw drive of the type mentioned in the introduction which, along with a straightforward construction and straightforward assembly sequence, readily allows the level of play or the prestressing of the individual nuts in relation to the threaded spindle to be set in a stepless and precise manner to a desired value.

This object is achieved according to the invention by a rolling-body screw drive of the type mentioned in the introduction in which an annular disk, which is connected to the first of the two individual nuts, is arranged between the two individual nuts and has its disk plane running essentially orthogonally to the spindle axis, is pressed, by way of at least one circumferential section, into an associated recess of the second individual nut. In comparison with the rolling-body screw drive which is known from the earlier-priority Patent Application DE 198 60 643.5, nevertheless published after the priority date, and likewise achieves the above object, this solution has the further advantage that it only requires a small amount of space, even in the axial direction, for arranging the annular disk between the two individual nuts.

As an extreme precaution, the disclosure of German Patent Application DE 198 60 643.5 will thus be incorporated by way of reference in the disclosure of the present application.

During the assembly of the rolling-body screw drive according to the invention, the rotationally fixed connection of the annular disk to the second individual nut may, according to a first method variant, be the last operation. For this purpose, the second individual nut is first of all brought into abutment, by rotation on the threaded spindle, against the annular disk, which is already connected to the first individual nut in a rotationally fixed manner. Further rotation of the two individual nuts then sets the desired level of play or the desired prestressing of the two individual nuts in relation to the threaded spindles. The only frictional forces occurring here between the annular disk and the nut stem from the prestressing itself. If the level of play or the prestressing has reached the desired value, at least one circumferential section of the annular disk is pressed into an associated recess of the second individual nut. This achieves a secure rotationally fixed connection which allows immediate further processing of the rolling-body screw drive. In addition, subsequent unintentional rotation of the two individual nuts relative to one another, with resulting adjustment of the desired level of play or of the desired prestressing, is reliably ruled out.

In order to simplify the assembly steps necessary for assembling the rolling-body screw drive according to the invention, it is also possible for the rotationally fixed connection of the annular disk to the first individual nut to be carried out by virtue of at least one circumferential section of the annular disk being pressed into an associated recess of the first individual nut. According to the first method alternative mentioned above, it is possible here, before the at least one circumferential section is pressed in, for the annular disk to be centered relative to the first individual nut using a centering pin.

It is basically also possible however, according to a second method alternative, for the annular disk to be connected to the two individual nuts in a rotationally fixed manner at the same time, to be precise advantageously in both cases by virtue of in each case at least one circumferential section of the annular disk being pressed into associated recesses of the two individual nuts. In this case, in order to simplify the assembly, it is conceivable for a centering extension for centering the annular disk to be provided on at least one of the individual nuts.

Irrespective of the method alternative which is used for assembly in each case, centering of the annular disk in relation to the first individual nut or in relation to both individual nuts has, quite generally, the advantage of facilitating the reproducible and precise assembly of the rolling-body screw drive according to the invention.

At most, during the assembly of the rolling-body screw drive according to the invention, there may be a problem if, when the desired prestressing or the desired level of play of the two individual nuts has been reached, two recesses of said individual nuts are located precisely opposite one another in the direction of the spindle axis. This is because the annular disk can only be connected in a form-fitting manner to one of the two individual nuts at a certain circumferential section. In order for it to be possible to remedy this, it is proposed that, when each of the individual nuts is connected to the annular disk at a predetermined number of circumferential sections, at least one of the individual nuts, preferably the second individual nut, has a larger number, preferably at least double the number, of recesses than corresponds to the predetermined number. In addition or as an alternative, it may nevertheless also be provided that, when an individual nut is provided with at least two recesses suitable for connection to the annular disk, said recesses are distributed irregularly over the circumference of the individual nut. Finally, this problem can also be countered in that annular disks of at least two different thicknesses are provided and, when it is established in relation to one disk thickness that the recesses of the two individual nuts are located opposite one another, said disk thickness is exchanged for an annular disk of a different thickness. It goes without saying the other disk thickness has to be selected such that, with this disk thickness, the problem of recesses being located opposite one another does not arise.

The annular disk preferably consists of soft, i.e. non-hardened, steel and can thus be produced, for example, by punching from sheet steel which can be obtained cost-effectively. This has the advantage that the annular disk, as an inexpensive series-production part, can be destroyed without undue concern during the dismantling of the rolling-body screw drive and can be replaced by a new annular disk during the renewed assembly of the two individual nuts.

The two individual nuts may be, for example, case-hardened individual nuts, i.e. individual nuts of which the rolling-body running surface is hardened by carburizing—and thus has a high carbon content—and is enclosed by an outer casing region made of a softer steel with a low carbon content. Such case-hardened individual nuts have the advantage that the soft casing region can also be easily worked by end users. For example, threaded bores can be made in these soft casing regions even with commercially available tools, which allows high-flexibility installation of the rolling-body screw drives according to the invention in primary structures. Moreover, the soft regions can be pressed into associated recesses of the primary structure. If at least the soft casing region is additionally produced from a weldable steel, that is to say, for example, from a steel with a low carbon content, then the rolling-body screw drive according to the invention may additionally be connected to the primary structure by welding. It is also basically possible, however, for the individual nuts to be induction-hardened. This hardening method, in which the steel which is to be hardened, rather being fed any carbon, is merely inductively heated, is suitable, in particular, for use with individual nuts which consist overall of high-carbon steel.

In a development of the invention, at least one circumferential section pressed into an associated recess is supported merely in the circumferential direction on that wall surface of the individual nut which bounds said recess. This reliably avoids forces which act both in the axial direction and in the radial direction and could influence the prestressing or the level of play of the two individual nuts in relation to the threaded spindle.

In order to reduce the forces necessary for the pressing-in operation and/or allow abutment of the pressed-in circumferential section against the largest possible surface area of the side walls of the recess, it may also be provided that the pressed-in circumferential section is indented.

In order to increase the stability of the overall arrangement, and thus to reduce the risk of deformation of the nuts, in particularly in the mutually facing end regions of the same, it may be provided that the at least one recess is boarded in the radially inward direction by a wall section of the associated individual nut.

In certain applications, it may be advantageous if the annular disk is additionally adhesively bonded to at least one of the two individual nuts, preferably using double-sided adhesive tape. Adhesive tapes with setting synthetic resins which are suitable for this application can be obtained, for example, under the name SCOTCH™ VHB™.

For as straightforward a construction as possible of the rolling-body screw drive according to the invention, it is also proposed that the two individual nuts be supported on one another in the direction of the spindle axis by means of the annular disk. It is basically also conceivable, however, for the two individual nuts to be supported directly on one another.

As has already been mentioned above, the invention also relates to a method of assembling a rolling-body screw drive according to the invention, in particular a ball screw drive. As far as the advantages of this method and the possible configurations of the same are concerned, you are referred to the above discussion of the rolling-body screw drive according to the invention.

The invention is described in more detail hereinbelow by way of an exemplary embodiment and with reference to the attached drawing, in which:

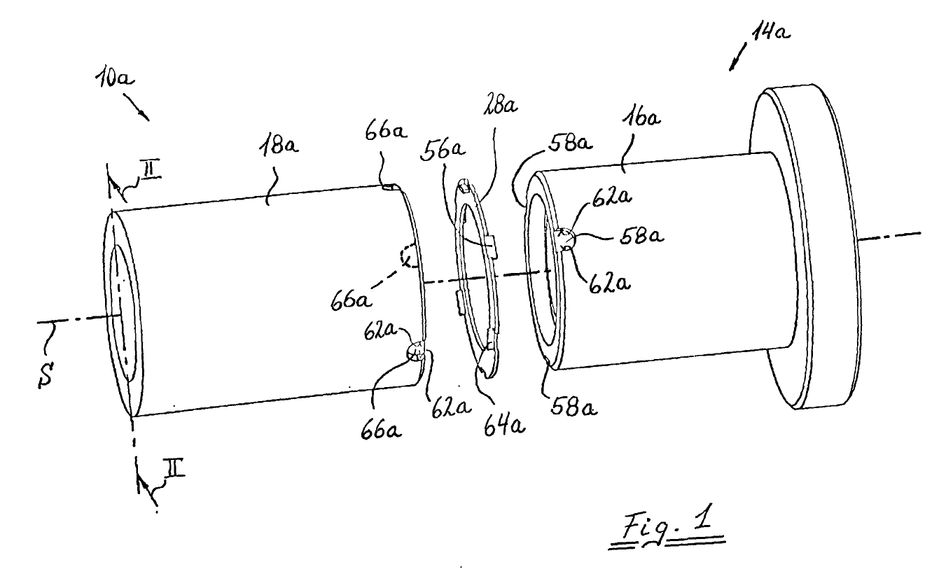

FIG. 1 shows an exploded illustration, in perspective, of a rolling-body screw drive according to the invention;

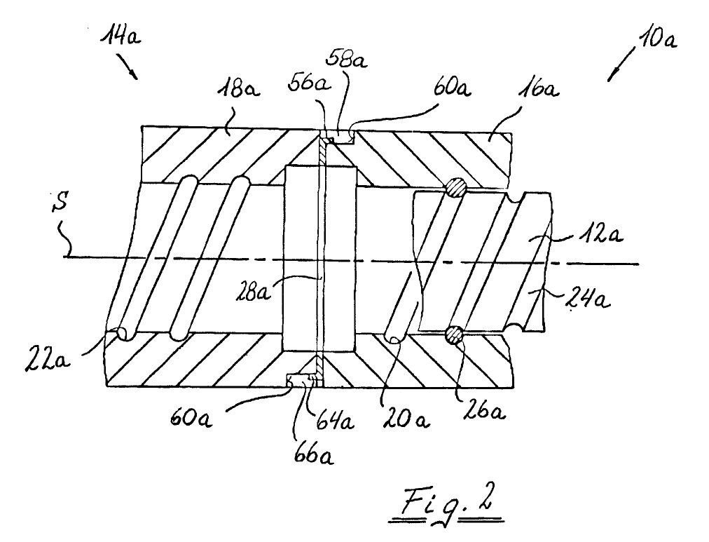

FIG. 2 shows a section of the rolling-body screw drive along line II-II in FIG. 1; and

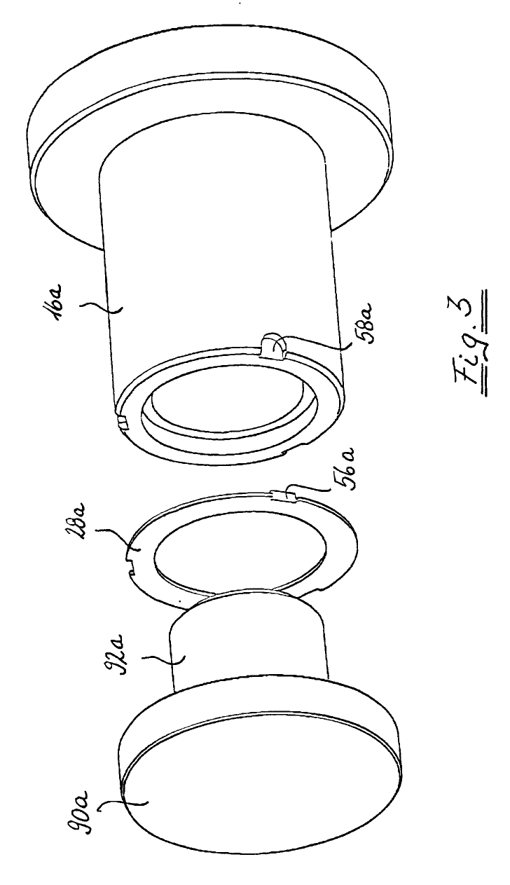

FIG. 3 shows a perspective view in order to explain the assembly of the rolling-body screw drive according to the invention.

In FIGS. 1 and 2, a rolling-body screw drive according to the invention is designated, quite generally, by 10a. The rolling-body screw drive 10a comprises a threaded spindle 12a (see FIG. 2) with a spindle axis S and a double nut 14a arranged concentrically with the threaded spindle 12a. The double nut 14a comprises a first individual nut 16a and a second individual nut 18a, which are connected to one another in a rotationally fixed manner as is explained in more detail hereinbelow.

The rolling-body running paths 20a and 22a of the two nuts 16a and 18a form, together with a rolling-body running path 24a of the spindle 12a, rolling-body running channels for rolling bodies 26a. In a manner which is conventional, and is thus not illustrated in the figures, the rolling-body running channels assigned to the two nuts 16a and 18a are rendered continuous via return channels formed in the casing of the nuts 16a, 18a, with the result that the rolling bodies assigned to the two nuts 16a and 18a, said rolling bodies being balls in the exemplary embodiment illustrated, circulate endlessly in said rolling-body running channels. In this way, a rotary movement of the spindle 12a about the axis S is converted into a linear movement of the guided double nut 14a in the direction of the axis S.

To this extent, the rolling-body screw drive 10a according to the invention corresponds to rolling-body screw drives known from the prior art.

Such rolling-body screw drives are used, for example, for the rapid and precise positioning of tool and workpiece carriers and for the displacement of the same at defined speeds. In order for it to be possible to meet the highest possible accuracy-related requirements upon reversal of the movement direction of the double nut 14a, it is necessary for the double nut 14a to run as far as possible in a play-free wanner on the spindle 12a. For this purpose, during assembly, the two nuts 16a and 18a are rotated toward one another on the spindle 12a until they butt against one another. If the nuts 16a and 18a are rotated further relative to one another, this results in the rolling bodies 26a in the running paths 20a and 22a butting against opposite flank surfaces of said running paths 20a and 22a. This results in prestressing of the two nuts 16a and 18a relative to the threaded spindle 12a. By virtue of this engagement of the rolling bodies 26a in different flank surfaces of the rolling paths 20a and 22a, the level of play of the double nut 14a in relation to the spindle 12a is reduced, if not eliminated altogether. In order that the abovedescribed prestressing is not eliminated again by rotation of the two nuts 16a, 18a relative to one another, said nuts are secured on one another in a rotationally fixed manner, to be precise using an annular disk 28a with its disk plane running essentially orthogonally to the spindle axis S.

The invention then comes in with respect to the manner of the rotationally fixed connection of said annular disk 28a to the two individual nuts 16a and 18a. This is because, according to the invention, this takes place by virtue of a plurality of circumferential sections 56a of the annular disk 22a being pressed or forced into recesses 58a of the first nut 16a and by virtue of a plurality of circumferential sections 64a of the annular disk 28a being pressed or forced into recesses 66a of the second nut 18a. For this purpose, the annular disk 28a is preferably produced from a soft steel, i.e. one which is not hardened and can be deformed, for example, with the aid of corresponding supporting means and of a ram or calking tool.

In order to avoid the situation where this manner of rotationally fixed connection influences the prestressing force of the two nuts 16a and 18a in relation to the threaded spindle 12a, it is preferred if, rather than being supported on the axial boundary surfaces 60a of the recesses 58a and 66a, the circumferential sections 56a, 64a are merely supported on the circumference boundary surfaces 62a of said recesses. If required, it is also possible for the forced-in or pressed-in circumferential sections 56a and 64a to be indented at locations corresponding to the circumference boundary surfaces 62a, although this is not illustrated either in FIG. 1 or in FIG. 2.

During assembly, it is possible, according to FIG. 3, for the annular desk 28a to be fitted, for example, first of all on the centering pin 92a of a centering tool 90a. Thereafter, said centering pin 92a is introduced into the first nut 16a, from that end region of the latter which has the recesses 58a, whereupon the circumferential section 56a can be pressed or forced into the recesses 58a. This produces a circumferentially form-fitting, rotationally fixed correction, which is centered, in particular, in relation to the spindle axis S, between the annular disk 28a and the first nut 16a. The further connection of the resulting unit 16a/28a to the second nut 18a can take place analogously following rotation of said unit onto the threaded spindle 12a and setting of the desired level of play or of the desired prestressing between the two nuts 16a and 18a. The centering of the second nut lea relative to the unit 16a/28a and relative to the spindle axis S is ensured here by the threaded spindle 12a.

During the assembly explained above, it is unfortunately not possible to rule out the situation where the desired prestressing or the desired level of play is achieved precisely when the recesses 58a of the first nut 16a and the recesses 66a of the second nut 18a are located precisely opposite one another in the direction of the spindle axis S. This is problematic insofar as the annular disk 28a can only be connected in a form-fitting manner to one of the two individual nuts 16a or 18a at a certain circumferential section. In order for it to be possible to remedy this, according to the invention, at least one of the nuts is provided with a larger number of recesses than the respectively other nut. In the exemplary embodiment illustrated, the number of recesses 66a in the second nut 18a is double that of the recesses 58a in the first nut 56a. Only one of the additional recesses 66a is indicated by dashed lines in FIG. 1. In addition or as an alternative, the recesses of at least one of the nuts 16a, 18a may be distributed irregularly over the circumference of said nut.

It is not possible for the double nut 14a to be dismantled from the threaded spindle 12a without being destroyed since, on account of the form-fitting engagement of the extensions 56a, 64a in the recesses 58a, 66a, neither of the two individual nuts 16a and 18a can be rotated relative to the annular disk 28a. In order for it to be possible for the rolling-body screw drive 10a to be dismantled from the spindle 12a, it would thus be necessary to destroy the extensions 56a or 64a on at least one of the sides of the annular disk.

It is more straightforward, however, for the double nut 14a to be dismantled using an auxiliary spindle with a smooth surface, which can be screwed into the double nut 14a instead of the threaded spindle 12a. Once the double nut 12a is located on said smooth auxiliary spindle, the two individual nuts 16a and 18a can readily be separated from one another, and from the annular disk 28a, in the axial direction, i.e. in the direction of the spindle axis S. This method of dismantling has the additional advantage that the annular disk 28a need not be destroyed and can be used again for renewed assembly.

1. A rolling-body screw drive (10a), in particular a ball screw drive, comprising:
a threaded spindle (12a) with a spindle axis (S), and
a double nut (14a) which runs on the threaded spindle (12a) and has two separately formed individual nuts (16a, 18a) which are connected essentially rigidly to one another in the direction of the spindle axis (S), it being the case that, for setting a desired level of play or a desired prestressing in relation to the threaded spindle (12a), the two individual nuts (16a, 18a) can be rotated continuously relative to one another about the spindle axis (S) and can be secured in a desired rotary position relative to one another corresponding to the desired level of play or the desired prestressing,
wherein an annular disk (28a), which is connected to a first (16a) of the two individual nuts, is arranged between the two individual nuts and has its disk plane running essentially orthogonally to the spindle axis (S), is pressed, by way of at least one circumferential section (64a) into an associated recess (66a) of the second individual nut (18a).

2. The rolling-body screw drive as claimed in claim 1, wherein the annular disk (28a) is also connected to the first individual nut (16a) by virtue of at least one circumferential section (56a) being pressed into an associated recess (58a) of the first individual nut (16a).

3. The rolling-body screw drive as claimed in claim 1 or 2, wherein at least one circumferential section (56a, 64a) pressed into an associated recess (58a, 66a) is supported merely in the circumferential direction (62a) on the wall surfaces bounding said recess (58a, 66a).

4. The rolling-body screw drive as claimed in one of claims 1 to 3, wherein at least one circumferential section (56a, 64a) pressed into an associated recess (58a, 66a) is indented.

5. The rolling-body screw drive as claimed in one of claims 1 to 4, wherein the at least one recess (58a, 66a) is bounded in a radially inward direction by a wall section of the associated individual nut (16a, 18a).

6. The rolling-body screw drive as claimed in one of claims 1 to 5, wherein, when each of the individual nuts (16a, 18a) is connected to the annular disk (28a) at a predetermined number of circumferential sections (56a, 64a), at least one of the individual nuts, preferably the second individual nut (18a), has a larger number, preferably at least double the number, of recesses (66a) than corresponds to the predetermined number.

7. The rolling-body screw drive as claimed in one of claims 1 to 6, wherein, when an individual nut (16a, 18a) is provided with at least two recesses (58a, 66a) suitable for connection to the annular disk (28a), said recesses are distributed irregularly over the circumference of the individual nut (16a, 18a).

8. The rolling-body screw drive as claimed in one of claims 1 to 7, wherein the two individual nuts (16a, 18a) are supported on one another in the direction of the spindle axis (S) by means of the annular disk (28a).

9. A method of assembling a rolling-body screw drive (10a), in particular ball screw drive, according to one of the preceding claims, in which method, for setting a desired level of play or a desired prestressing, the two individual nuts (16a, 18a) are brought into mutual abutment by rotation on the threaded spindle (12a) and are connected to one another in a rotationally fixed manner in a rotary position relative to one another corresponding to the desired level of play or the desired prestressing, wherein, for fixing the rotary position of the two individual nuts (16a, 18a) relative to one another, an annular disk (28a), which is connected to a first (16a) of the two individual nuts, is arranged between the two individual nuts and has its disk plane running essentially orthogonally to the spindle axis (S), is pressed, by way of at least one circumferential section (64a), into an associated recess (66a) of the second individual nut (18a).

10. The method as claimed in claim 9, wherein the connection of the annular disk (28a) to the first individual nut (16a) is also produced by virtue of at least one circumferential section (56a) of the annular disk being pressed into an associated recess (58a) of the first individual nut (16a).

11. The method as claimed in claim 10, wherein, before the at least one circumferential section (56a) is pressed in, the annular disk (28a) is centered relative to the first individual nut (16a) using a centering pin (92a).

12. The method as claimed in one of claims 9 to 11, wherein at least two annular disks (28a) of different thicknesses are provided and, when it is established in relation to one of the annular disks that the recesses (58a, 66a) of the two individual nuts (14a, 16a) are located opposite one another, said annular disk is exchanged for an annular disk of a different thickness.
